(19) United States
(12) Patent Application Publication
(10) Pub. No.: US 2025/0130351 A1
(43) Pub. Date: Apr. 24, 2025

(54) METHOD FOR PREPARING TUNABLE ANTI-REFLECTIVE COATING, TUNABLE ANTI-REFLECTIVE COATING, AND LENS

(71) Applicant: SUZHOU CITY UNIVERSITY, Suzhou (CN)

(72) Inventors: Fang CAO, Suzhou (CN); Lei Gao, Suzhou (CN); Chenglin Wang, Suzhou (CN); Fang Peng, Suzhou (CN)

(21) Appl. No.: 18/932,223

(22) Filed: Oct. 30, 2024

Related U.S. Application Data
(63) Continuation of application No. PCT/CN2023/125923, filed on Oct. 23, 2023.

(51) Int. Cl. G02B 1/115

(52) U.S. Cl. CPC G02B 1/115

(57) ABSTRACT

The invention provides a method for preparing a tunable anti-reflective coating, including: measuring electromagnetic wave impedances X1 and X2 of a first and second medium; doping a substrate to obtain an anti-reflective coating whose internal electromagnetic wave impedance changes with a wavelength or thickness; measuring an electromagnetic wave impedance X3 on a side of the anti-reflective coating in contact with the first medium and an electromagnetic wave impedance X4 on a side of the anti-reflective coating in contact with the second medium; and comparing X1 and X3, and X2 and X4, when X1=X3 and X2=X4, obtaining a tunable anti-reflective coating that matches the first and second medium, or when X1#X3 and/or X2#X4, adjusting the thickness of the first anti-reflective coating until X1=X3 and X2=X4, and obtaining a tunable anti-reflective coating that matches the first and second medium.

This application is a Continuation Application of PCT/CN2023/125923, filed on Oct. 23, 2023, which is incorporated by reference for all purposes as if fully set forth herein.

### FIELD OF THE INVENTION

The present invention relates to the field of anti-reflective coating technologies, and specifically to a method for preparing a tunable anti-reflective coating, a tunable anti-reflective coating, and a lens.

### DESCRIPTION OF THE RELATED ART

An electromagnetic wave anti-reflective coating is configured to reduce the reflection on the surfaces of optical and electromagnetic components to increase the transmissivity of light waves and electromagnetic waves in a working band, and is an indispensable important component in optical and electromagnetic devices.

At present, there are mainly four types of common anti-reflective coatings: (1) a dielectric anti-reflective coating; (2) a gradient structural surface anti-reflective coating; (3) a conductive film anti-reflective coating; and (4) an electromagnetic metamaterial anti-reflective coating.

The dielectric anti-reflective coating is usually based on the destructive interference principle of reflected waves. The anti-reflective coating is easy to prepare, but requires at least a quarter-wave optical thickness. Therefore, for a long band, the anti-reflective coating has a large thickness, and is therefore not applicable to a wide frequency band range and a wide angle range.

In the gradient structural surface anti-reflective coating, the structure on the surface thereof is designed to implement a continuous transition from an impedance of an incident medium to an impedance of an emergent medium, thereby reducing or even eliminating reflected waves. The anti-reflective coating can work in a wide frequency band range and a wide angle range, but has a high actual preparation difficulty, resulting in a low yield and inapplicability to conventional production and processing.

In the conductive film anti-reflective coating, a transition between impedances of different materials is implemented by regulating an impedance of a conductive film, thereby eliminating reflected waves. The anti-reflective coating has a small thickness and a light and thin product, but has the problem of energy loss caused by electrical conductivity.

The electromagnetic metamaterial anti-reflective coating is a novel anti-reflective coating, and is an appropriate design based on a novel electromagnetic material, i.e., an electromagnetic metamaterial. Reflection can be regulated and eliminated by generating electrical resonance and magnetic resonance in the electromagnetic metamaterial. The anti-reflective coating has an advantage of a thickness being far smaller than that of a conventional product, but still has a limited use range. The anti-reflective coating can only work in a narrow frequency band range and a narrow angle range, and the use thereof depends on the polarization of incident electromagnetic waves. Therefore, the actual design, preparation, and use are very difficult.

In the existing anti-reflective coatings above, one anti-reflective coating is only correspondingly applicable to an anti-reflection requirement of one material. In other words, if an application scenario has changed, it is necessary to correspondingly redesign and process an anti-reflective coating. In recent years, no breakthrough has been made in researching and preparing an anti-reflective coating with coordination and universality.

### SUMMARY OF THE INVENTION

For this, a technical problem to be resolved by the present invention is to overcome the problem that an anti-reflective coating in the prior art requires complex preparation, allows no coordination, and lacks universality, and provide a method for preparing a tunable anti-reflective coating, a tunable anti-reflective coating, and a lens.

To resolve the foregoing technical problems, the present invention provides a method for preparing a tunable anti-reflective coating. The tunable anti-reflective coating is disposed between a first medium and a second medium, and the method includes the following steps: S1: respectively measuring electromagnetic wave impedances X1 and X2 of the first medium and the second medium; S2: doping a substrate according to X1 and X2 to obtain a first anti-reflective coating whose internal electromagnetic wave impedance changes with a wavelength of an electromagnetic wave or a thickness; S3: measuring an electromagnetic wave impedance X3 on a side of the first anti-reflective coating in contact with the first medium and an electromagnetic wave impedance X4 on a side of the first anti-reflective coating in contact with the second medium; and S4: comparing values of X1 and X3, and comparing values of X2 and X4, and when X1=X3 and X2=X4, obtaining a tunable anti-reflective coating that respectively matches the first medium and the second medium, or when X1≠X3 and/or X2≠X4, adjusting the thickness of the first anti-reflective coating until X1=X3 and X2=X4, and obtaining a tunable anti-reflective coating that respectively matches the first medium and the second medium.

In an embodiment of the present invention, the substrate is a first substrate for which wave impedance matching is performed by tuning a transverse electric wave, or a second substrate for which wave impedance matching is performed by tuning a transverse magnetic wave.

In an embodiment of the present invention, the first substrate is a double-zero material with both permittivity and permeability approximating to zero or a dielectric photonic crystal.

In an embodiment of the present invention, the second substrate is a double-zero material with both permittivity and permeability approximating to zero or a single-zero material with a permittivity being zero and a relative permeability being 1.

In an embodiment of the present invention, the first medium and the second medium is independently selected from the group consisting of air, glass, silicon, silicon nitride, gallium arsenide, germanium, aluminum oxide, plastic, organic glass, iron oxide and ferroferric oxide.

In an embodiment of the present invention, a doped substance in Step S2 includes a dielectric material and a wave-absorbing material.

In an embodiment of the present invention, the dielectric material is selected from glass, plastic, or ceramic, and the wave-absorbing material is selected from ultrafine metal powder, silicon carbide powder, silicon carbide fiber, carbon fiber, metal fiber, or an organic polymer.

In an embodiment of the present invention, in Step S2, a doping ratio matches a doped substance and a type of the substrate.

To resolve the foregoing technical problems, the present invention further provides a tunable anti-reflective coating, prepared by using the foregoing method for preparing a tunable anti-reflective coating.

To resolve the foregoing technical problems, the present invention further provides a lens, including the foregoing tunable anti-reflective coating and a lens body, where the tunable anti-reflective coating covers an outer side of the lens body.

Compared with the prior art, the foregoing technical solution of the present invention has the following advantages:

The method for preparing a tunable anti-reflective coating and the tunable anti-reflective coating in the present invention make a breakthrough in the design idea of a conventional anti-reflective coating. A special substrate is doped to make it possible to make adjustments corresponding to electromagnetic waves of different media separately on two sides of the substrate, and then polishing is performed to obtain an anti-reflective coating that can separately match electromagnetic waves of two different media to eliminate reflection. The tunable anti-reflective coating can overcome the problem that an anti-reflective coating in the prior art requires complex preparation, allows no coordination, and lacks universality, can adapt to anti-reflection requirements of different media, and has low preparation costs, light and thin products, and a wide application range, and therefore has great value and a development prospect in the industry.

### BRIEF DESCRIPTION OF THE DRAWINGS

To make the content of the present invention clearer and more comprehensible, the present invention is further described in detail below according to specific embodiments of the present invention and the accompanying drawings.

FIG. 1 is a principle diagram of preparing a transverse magnetic wave anti-reflective coating according to a preferred embodiment of the present invention;

FIG. 2 is a statistical chart of linear changes and a distribution diagram of a magnetic field real part of a transverse magnetic wave anti-reflective coating when α>0 in FIG. 1;

FIG. 3 is a diagram of numerical simulation results of a transverse magnetic wave anti-reflective coating when α>0 in FIG. 1;

FIG. 4 is a diagram of numerical simulation results of a transverse magnetic wave anti-reflective coating when α<0 in another embodiment of the present invention;

FIG. 5 is a principle diagram of preparing a transverse electric wave anti-reflective coating according to another embodiment of the present invention;

FIG. 6 is a statistical chart of linear changes and a distribution diagram of a magnetic field real part of a transverse electric wave anti-reflective coating when β>0 in FIG. 5;

FIG. 7 is a diagram of numerical simulation results of a transverse electric wave anti-reflective coating when β>0 in FIG. 5;

FIG. 8 is a diagram of numerical simulation results of a transverse electric wave anti-reflective coating when β<0 in another embodiment of the present invention; and

FIG. 9 is a schematic diagram of verification results in FIG. 8.

### DETAILED DESCRIPTION OF THE PREFERRED EMBODIMENTS

The present invention is further described below with reference to the accompanying drawings and specific embodiments, to enable a person skilled in the art to better understand and implement the present invention. However, the embodiments are not used to limit the present invention.

### Embodiment 1

This embodiment provides a method for preparing a tunable anti-reflective coating. The tunable anti-reflective coating is disposed between a first medium and a second medium, and the method includes the following steps: S1: respectively measuring electromagnetic wave impedances X₁ and X₂ of the first medium and the second medium; S2: doping a substrate according to X₁ and X₂ to obtain a first anti-reflective coating whose internal electromagnetic wave impedance changes with a wavelength of an electromagnetic wave or a thickness; S3: measuring an electromagnetic wave impedance X₃ on a side of the first anti-reflective coating in contact with the first medium and an electromagnetic wave impedance X₄ on a side of the first anti-reflective coating in contact with the second medium; and S4: comparing values of X₁ and X₃, and comparing values of X₂ and X₄, and when X₁=X₃ and X₂=X₄, obtaining a tunable anti-reflective coating that respectively matches the first medium and the second medium, or when X₁≠X₃ and/or X₂≠X₄, adjusting the thickness of the first anti-reflective coating until X₁=X₃ and X₂=X₄, and obtaining a tunable anti-reflective coating that respectively matches the first medium and the second medium. The method for preparing a tunable anti-reflective coating in the present invention makes a breakthrough in the design idea of a conventional anti-reflective coating. A special substrate is doped to make it possible to make adjustments corresponding to electromagnetic waves of different media separately on two sides of the substrate, and then polishing is performed to obtain an anti-reflective coating that can separately match electromagnetic waves of two different media to eliminate reflection. The product thereof can adapt to anti-reflection requirements of different media, and has low preparation costs, light and thin products, and a wide application range, and therefore has great value and a development prospect in the industry.

In this embodiment, an anti-reflective function is implemented by matching transverse magnetic waves (referred to as TM waves for short below). A preparation process is specifically as follows:
S1: Respectively measure electromagnetic wave impedances of the first medium and the second medium. Specifically, in this embodiment, the first medium is air and has an electromagnetic wave impedance of 376.73 Ω. The second medium is gallium arsenide and has an electromagnetic wave impedance of 139.86 Ω.
S2: Dope a substrate to obtain a first anti-reflective coating whose internal electromagnetic wave impedance changes with a wavelength of an electromagnetic wave or a thickness. Further, in this embodiment, the substrate is a second substrate for which wave impedance matching is performed by tuning a transverse magnetic wave. In this embodiment, the second substrate is a double-zero material with both permittivity and permeability approximating to zero, and a doped substance is a dielectric material. Further, the doped substance is ceramic.
S3: Measure an electromagnetic wave impedance being 377.25 Ω on a side of the first anti-reflective coating in contact with the air and an electromagnetic wave impedance being 135.42 Ω on a side of the first anti-reflective coating in contact with the gallium arsenide.
S4: Compare values of X₁ and X₃, and compare values of X₂ and X₄. In this embodiment,
X₁#X₃ and X₂#X₄. Therefore, the thickness of the first anti-reflective coating is adjusted, and it can be implemented that X₁=X₃ and X₂=X₄ after the thickness thereof is adjusted to 299 mm, to obtain a tunable anti-reflective coating that respectively matches the air and the gallium arsenide. In this embodiment, the first anti-reflective coating is cut to change the thickness thereof, and a cutting process can be performed repeatedly to improve the precision of the anti-reflective coating.

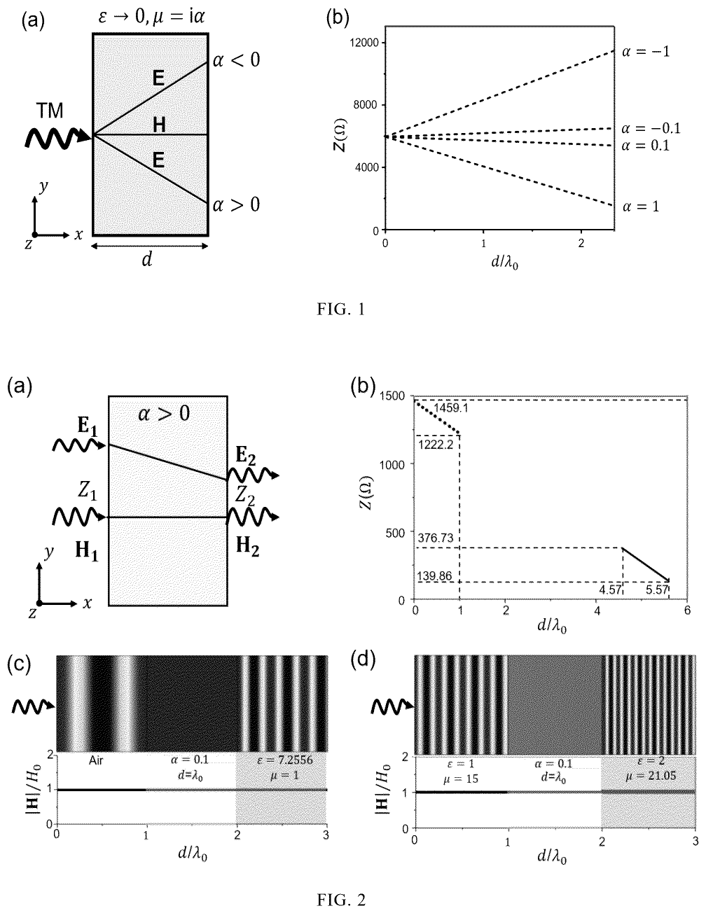

Referring to FIG. 1, the TM wave has a magnetic field vibrating in a z direction and an electric field vibrating in a y direction, and perpendicularly enters a zero-index material with a relative permittivity approximating to zero (i.e., ε approximates to 0) and a relative permeability being an imaginary number (μ=iα). As can be learned from the Maxwell equation, the magnetic field H_{z} of the zero-index material is a constant value, and the electric field meets a relationship of E_{y}=iωμ₀μH_{z}d+E_{y0}. μ=iα is introduced into the foregoing parameters. It can be obtained that E_{y}=−ωμ₀αH_{z}d+E_{y0}, i.e., the electric field attenuates linearly as a propagation distance increases. ω is an angular frequency of an incident wave. μ₀ is a vacuum magnetic permeability, d is a propagation length of an electromagnetic wave in the material, and E_{y0} is an initial electric field amplitude. As shown in FIG. 1(a), when α>0, the electric field attenuates linearly, and when α<0, the electric field increases linearly.

Further, as can be learned from the wave impedance formula z=E_{y}/H_{z}, the wave impedance in the zero-index material changes along with the propagation length of the electromagnetic wave or the thickness of the material and α. FIG. 1(b) is a diagram of a wave impedance changing along with a propagation distance d when αis 1, −1, 0.1, and −0.1. As can be seen, when α>0, the wave impedance attenuates linearly, and when α<0, the wave impedance increases linearly. When the absolute value of α is larger, a change slope of the wave impedance is larger.

Refer to FIG. 2. FIG. 2 shows a model of a TM anti-reflective coating when α>0. As shown in FIG. 2(a), the magnetic field remains unchanged in the anti-reflective coating, and the electric field decreases linearly in the anti-reflective coating. When α=0.1, the wave impedance in the anti-reflective coating is shown in FIG. 2(b). In this embodiment, Material 1 is air and has a wave impedance of 376.73 Ω, and Material 2 has a relative permittivity of ε=7.2556, a relative permeability of μ=1, and a wave impedance of 139.86 Ω. As can be learned from data in FIG. 4(b), when d=4.57λ₀ to 5.77 λ₀ (λ₀ is the thickness), as shown by the black solid line in FIG. 4(b), an anti-reflection effect can be implemented. FIG. 4(c) gives numerical simulation results. The upper diagram is a distribution diagram of a normalized magnetic field real part, and the lower diagram is a distribution diagram of a normalized magnetic field amplitude. It can be learned that the normalized magnetic field amplitude in air at an incident end is 1, indicating that there is nearly no reflected waves in this model, i.e., the anti-reflective coating has an excellent anti-reflection effect.

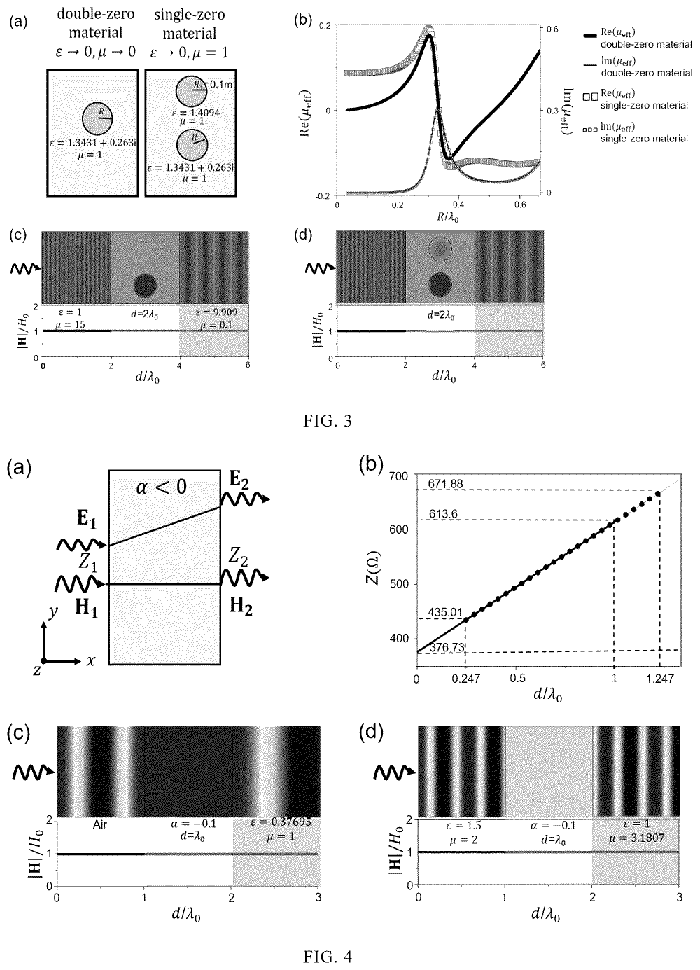

Refer to FIG. 3. In FIG. 3(a), an incident wave has a frequency of 1 GHz and a wavelength of 0.299 m, and a circular impurity with ε=1.3431+0.263i and μ=1 and a variable radius R is added to a double-zero material with a width of d=0.6 m and a height of h=0.6 m. A real part and an imaginary part of an equivalent relative permeability μ_{eff} of the whole material change as the radius R of the circular impurity changes, as shown in FIG. 3(b). When the radius R=0.333 λ₀, i.e., 0.1 m, the black thick solid line represents that the real part of μ_{eff} is 0, and the black thin solid line represents that the imaginary part of μ_{eff} is 0.3. In this case, the material doped with the impurity equivalently has & approximating to 0, and μ=0.3i, i.e., α=0.3. An impedance of an intermediate material is changed, and impedance matching is separately performed with Material 1 and Material 2. Material 1 has ε=1 and μ=15, and Material 2 has ε=9.909 and μ=0.1. Numerical simulation results are shown in FIG. 3(c). The reflection of the surface of the electromagnetic material is 0.

### Embodiment 2

In this embodiment, an anti-reflective function is implemented by matching TM waves. A preparation process is specifically as follows:
S1: Respectively measure electromagnetic wave impedances of the first medium and the second medium. Specifically, in this embodiment, the first medium is air and has an electromagnetic wave impedance of 376.73 Ω. The second medium is iron oxide and has an electromagnetic wave impedance of 613.60 Ω.
S2: Dope a substrate to obtain a first anti-reflective coating whose internal electromagnetic wave impedance changes with a wavelength of an electromagnetic wave or a thickness. Further, in this embodiment, the substrate is a second substrate for which wave impedance matching is performed by tuning a transverse magnetic wave. In this embodiment, the second substrate is a single-zero material with a permittivity being zero and a relative permeability being 1. Further, the doped substance is plastic.
S3: Measure an electromagnetic wave impedance being 377.25 Ω on a side of the first anti-reflective coating in contact with the air and an electromagnetic wave impedance being 615.23 Ω on a side of the first anti-reflective coating in contact with the iron oxide.
S4: Compare values of X₁ and X₃, and compare values of X₂ and X₄. In this embodiment,
X₁≠X₃ and X₂≠X₄. Therefore, the thickness of the first anti-reflective coating is adjusted, and it can be implemented that X₁=X₃ and X₂=X₄ after the thickness thereof is adjusted to 299 mm, to obtain a tunable anti-reflective coating that respectively matches the air and the iron oxide. In this embodiment, the first anti-reflective coating is cut to change the thickness thereof, and a cutting process can be performed repeatedly to improve the precision of the anti-reflective coating.

Referring to FIG. 4, the anti-reflection effect of the TM anti-reflective coating when α<0 is verified in this embodiment. In the anti-reflective coating, Material 1 is air (having a wave impedance of 376.73 Ω), and Material 2 has a relative permittivity of ε=0.37695 and a relative permeability of μ=1 (having a wave impedance of 613.6 Ω). As can be learned from data in FIG. 4(b), when d=0 to λ₀ (λ₀ is the thickness), as shown by the black solid line in FIG. 5(b), an anti-reflection effect can be implemented. FIG. 4(c) gives numerical simulation results. The upper diagram is a distribution diagram of a normalized magnetic field real part, and the lower diagram is a distribution diagram of a normalized magnetic field amplitude. It can be learned that the normalized magnetic field amplitude in air at an incident end is 1, indicating that there is nearly no reflected waves in this model, i.e., the anti-reflective coating has an excellent anti-reflection effect.

Similarly, a single-zero material with a permittivity approximating to zero and a relative permeability being 1 is doped. Referring to the right diagram of FIG. 8(a), an incident wave has a frequency of 1 GHz and a wavelength of 0.299 m, and a circular impurity with ε=1.3431+0.263i and μ=1 and a variable radius R is also added to a single-zero material with a width of d=0.6 m and a height of h=0.6 m, and a circular impurity with ε=1.4094, μ=1, and R1=0.1 m is added. The whole material has an equivalent relative permeability μ_{eff}, and a real part and an imaginary part of μ_{eff} change as the radius R of the circular impurity changes, as shown in FIG. 8(b). When the radius R=0.333 λ₀, i.e., 0.1 m, the black thick dotted line represents that the real part of μ_{eff} is 0, and the black thin dotted line represents that the imaginary part of μ_{eff} is 0.3. In this case, the material doped with the impurity equivalently has ε approximating to 0, and μ=0.3i, i.e., α=0.3. An impedance of an intermediate material is changed, and impedance matching is separately performed with Material 1 and Material 2. Similarly, Material 1 has ε=1 and μ=15, and Material 2 has ε=9.909 and μ=0.1. Through COSMOL simulation, as shown in FIG. 8(c). The reflection of the surface of the electromagnetic material is still 0.

### Embodiment 3

In this embodiment, an anti-reflective function is implemented by matching transverse electric waves (referred to as TE waves for short below). A preparation process is specifically as follows:
S1: Respectively measure electromagnetic wave impedances of the first medium and the second medium. Specifically, in this embodiment, the first medium is air and has an electromagnetic wave impedance of 376.73 Ω. The second medium is ferroferric oxide and has an electromagnetic wave impedance of 3150.7 Ω.
S2: Dope a substrate to obtain a first anti-reflective coating whose internal electromagnetic wave impedance changes with a wavelength of an electromagnetic wave or a thickness. Further, in this embodiment, the substrate is a first substrate for which wave impedance matching is performed by tuning a transverse electric wave. In this embodiment, the first substrate is a double-zero material with both permittivity and permeability approximating to zero. Further, a doped substance is a wave-absorbing material, and is specifically ultrafine metal powder.
S3: Measure an electromagnetic wave impedance being 377.25 Ω on a side of the first anti-reflective coating in contact with the air and an electromagnetic wave impedance being 3150.7 Ω on a side of the first anti-reflective coating in contact with the ferroferric oxide.
S4: Compare values of X₁ and X₃, and compare values of X₂ and X₄. In this embodiment,
X₁≠X₃ and X₂≠X₄. Therefore, the thickness of the first anti-reflective coating is adjusted, and it can be implemented that X1=X3 and X2=X4 after the thickness thereof is adjusted to 598 mm, to obtain a tunable anti-reflective coating that respectively matches the air and the ferroferric oxide. In this embodiment, the first anti-reflective coating is cut to change the thickness thereof, and a cutting process can be performed repeatedly to improve the precision of the anti-reflective coating.

Referring to FIG. 5, the TE wave has an electric field vibrating in a z direction and a magnetic field vibrating in a y direction, and perpendicularly enters a zero-index material with a relative permittivity being an imaginary number (i.e., ε=iβ) and a relative permeability approximating to zero (i.e., μ approximates to 0). As can be learned from the Maxwell equation, the electric field E_{z} of the zero-index material is a constant value, and the magnetic field meets a relationship of H_{y}=iωε₀εE_{z}d+H_{y0}. ε=iβ is introduced into the foregoing parameters. H_{y}=−ωε₀βE_{z}d+H_{y0}, i.e., the magnetic field attenuates linearly as a propagation distance increases. ε₀ is permittivity of vacuum, and H_{y0} is the magnetic-field amplitude of incidence. As shown in FIG. 5(a), when β>0, the magnetic field attenuates linearly, and when β<0, the magnetic field increases linearly.

As can be obtained from the wave impedance formula Z=E_{y}/H_{z}, the wave impedance in the zero-index material changes along with the propagation length of the electromagnetic wave or the thickness of the material and β. FIG. 5(b) is a diagram of a wave impedance changing along with a propagation distance d when β is 0.07, −0.07, 0.01, and −0.01. As can be seen, when β>0, the wave impedance decreases along with the propagation distance, and when β<0, the wave impedance increases along with the propagation distance. When the absolute value of β is larger, the change of the wave impedance is more rapid.

The foregoing results show that the effective regulation can be implemented by changing B and the thickness of the zero-index material. When a wave impedance on the left-side interface of the zero-index material matches the wave impedance of Material 1 and a wave impedance on the right-side interface of the zero-index material matches the wave impedance of Material 2, an anti-reflective coating function can be implemented.

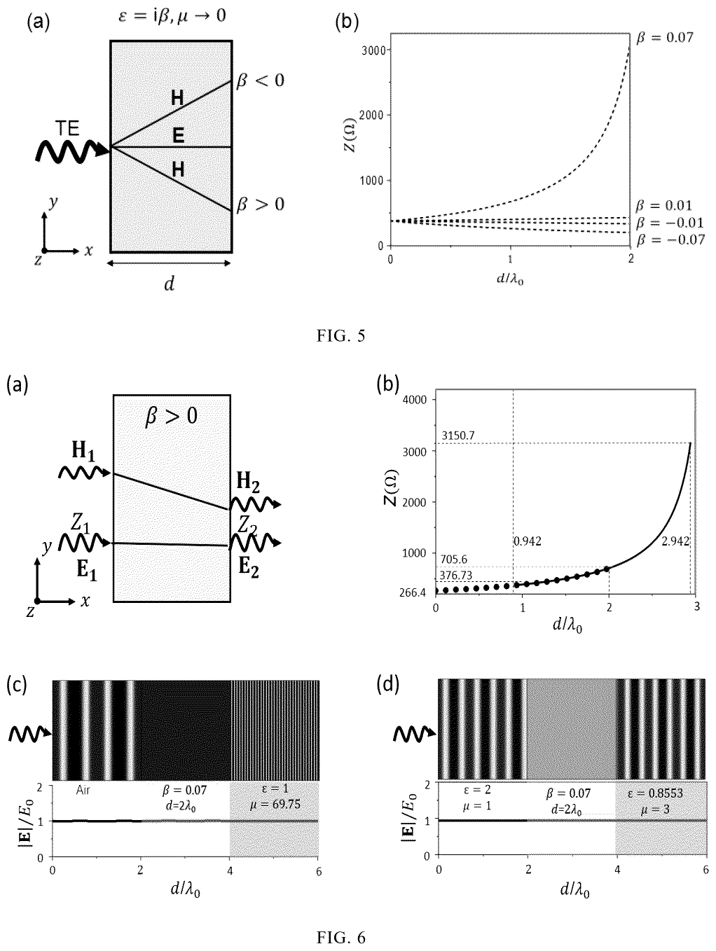

Refer to FIG. 6. To verify the TE anti-reflective coating, the model with β>0 is first considered. As shown in FIG. 6(a), the electric field remains unchanged in the anti-reflective coating, and the magnetic field attenuates linearly in the anti-reflective coating. When β=0.07, the wave impedance in the anti-reflective coating is shown in FIG. 6(b). To verify the effect of the anti-reflective coating numerically, the following two examples are used.

(1) Material 1 is air (having a wave impedance of 376.73 Ω), and Material 2 has β=1 and a permeability of μ=69.75 (having a wave impedance of 3150.7 Ω). As can be learned from data in FIG. 6(b), when d=0.942λ₀ to 2.942λ₀ (i.e., a thickness of 2λ₀), as shown by the black solid line in FIG. 6(b), an anti-reflection effect can be implemented. FIG. 6(c) gives numerical simulation results. The upper diagram is a distribution diagram of a normalized electric field real part, and the lower diagram is a distribution diagram of a normalized electric field amplitude. It can be learned that the normalized electric field amplitude in air at an incident end is 1, indicating that there is nearly no reflected waves in this model, i.e., the anti-reflective coating has an excellent anti-reflection effect.

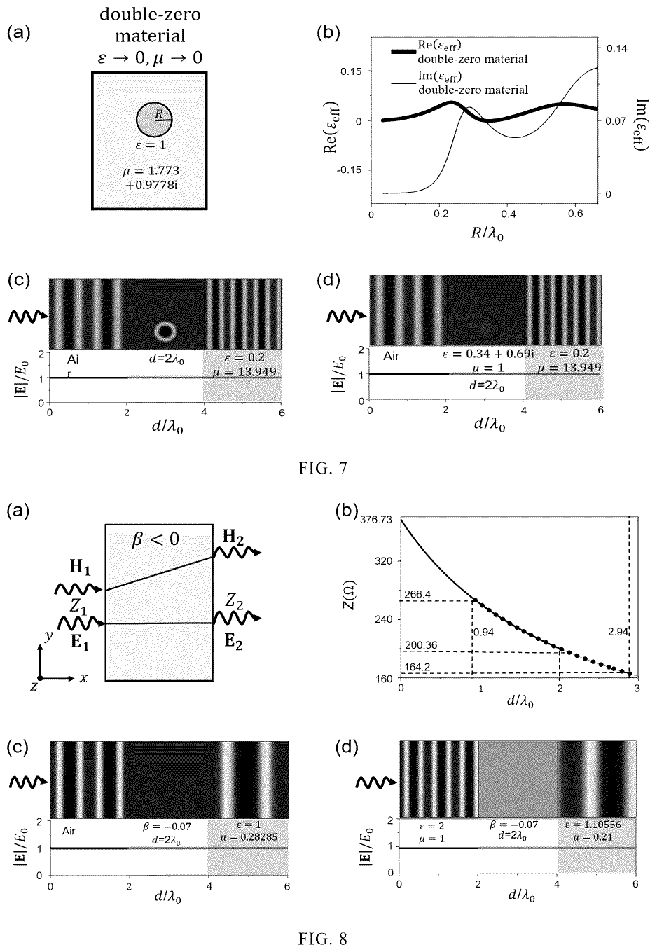

Referring to FIG. 7, a double-zero material with both permittivity and permeability approximating to zero is doped. As shown in FIG. 7(a), an incident wave has a frequency of 1 GHz and a wavelength of 0.299 m, and a circular impurity with μ=1.773+0.9778i and ε=1 and a variable radius R is added to a double-zero material with a width of d=0.6 m and a height of h=0.6 m. The whole material has an equivalent relative permittivity ε_{eff}. A real part and an imaginary part of ε_{eff} change as the radius R of the circular impurity changes, as shown in FIG. 7(b). When the radius R=0.333 λ₀, i.e., 0.1 m, the black thick solid line represents that the real part of ε_{eff} is 0, and the black thin solid line represents that the imaginary part of ε_{eff} is 0.07. In this case, the material doped with the impurity equivalently has ε=0.07i, i.e., μ approximates to 0. An impedance of an intermediate material is changed, and impedance matching is separately performed with Material 1 and Material 2. Material 1 is air, and Material 2 has ε=0.2 and ε=13.949, through COSMOL simulation, as shown in FIG. 7(c). The reflection of the surface of the electromagnetic material is 0.

### Embodiment 4

In this embodiment, an anti-reflective function is implemented by matching TE waves. A preparation process is specifically as follows:
S1: Respectively measure electromagnetic wave impedances of the first medium and the second medium. Specifically, in this embodiment, the first medium is air and has an electromagnetic wave impedance of 376.73 Ω. The second medium is silicon nitride and has an electromagnetic wave impedance of 200.36 Ω.
S2: Dope a substrate to obtain a first anti-reflective coating whose internal electromagnetic wave impedance changes with a wavelength of an electromagnetic wave or a thickness. Further, in this embodiment, the substrate is a first substrate for which wave impedance matching is performed by tuning a transverse electric wave.

In this embodiment, the first substrate is a double-zero material with both permittivity and permeability approximating to zero. Further, a doped substance is a wave-absorbing material, and is specifically ultrafine metal powder.
S3: Measure an electromagnetic wave impedance being 377.25 Ω on a side of the first anti-reflective coating in contact with the air and an electromagnetic wave impedance being 202.52 Ω on a side of the first anti-reflective coating in contact with the silicon nitride.
S4: Compare values of X₁ and X₃, and compare values of X₂ and X₄. In this embodiment,
X₁≠X₃ and X₂≠X₄. Therefore, the thickness of the first anti-reflective coating is adjusted, and it can be implemented that X₁=X₃ and X₂=X₄ after the thickness thereof is adjusted to 598 mm, to obtain tunable anti-reflective coatings that respectively match the air and the silicon nitride. In this embodiment, the first anti-reflective coating is cut to change the thickness thereof, and a cutting process can be performed repeatedly to improve the precision of the anti-reflective coating.

Referring to FIG. 8, the anti-reflection effect of the TE anti-reflective coating when β<0 is verified in this embodiment. As shown in FIG. 8(a), the electric field remains unchanged in the anti-reflective coating, and the magnetic field increases linearly in the anti-reflective coating. When β=−0.07, the wave impedance in the anti-reflective coating is shown in FIG. 7(b).

Material 1 is air (having a wave impedance of 376.73 Ω), and Material 2 has a relative permittivity of ε=1 and a relative permeability of μ=0.28285 (having a wave impedance of 200.36 Ω). As can be learned from data in FIG. 8(b), when d=0 to 2λ₀ (i.e., a thickness of 2λ₀), as shown by the black solid line in FIG. 8(b), an anti-reflection effect can be implemented. FIG. 7(c) gives numerical simulation results. The upper diagram is a distribution diagram of a normalized electric field real part, and the lower diagram is a distribution diagram of a normalized electric field amplitude. It can be learned that the normalized electric field amplitude in air at an incident end is 1, indicating that there is nearly no reflected waves in this model, i.e., the anti-reflective coating has an excellent anti-reflection effect.

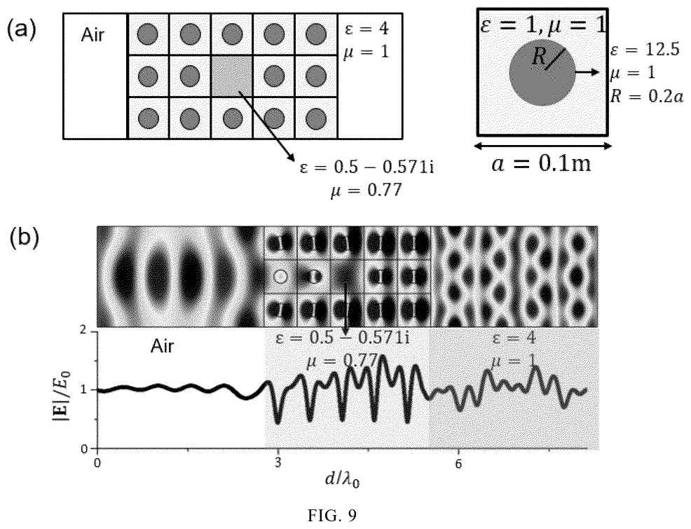

Referring to FIG. 9, a dielectric photonic crystal is doped for implementation. As shown by the right diagram of FIG. 10(a), the photonic crystal is formed by arranging dielectric cylinders (having a relative permittivity of ε=12.5 and a relative permeability of μ=1) according to a square lattice (a lattice constant of α=0.1 m), and the background material is air. The structural unit of the photonic crystal is shown by the right diagram of FIG. 10(a), the radius of the dielectric cylinder is R=0.2α. An incident wave has a frequency of 1.6227 GHz.

To implement an anti-reflective coating function, a square impurity with a relative permittivity of ε=10.5−0.571i and a relative permeability of λ=0.77 is doped at the center of the photonic crystal. Material 1 on the left side of the photonic crystal is air, and Material 2 on the right side of the photonic crystal is a dielectric material with a relative permittivity of ε=4 and a relative permeability of λ=1. FIG. 10(b) gives numerical simulation results. The results show that the reflection of the system is close to zero, indicating an excellent anti-reflective coating effect.

### Embodiment 5

This embodiment provides a tunable anti-reflective coating, prepared by using the method for preparing a tunable anti-reflective coating in Embodiment 1.

### Embodiment 6

This embodiment provides a lens, including the tunable anti-reflective coating in Embodiment 5 and a lens body, where the tunable anti-reflective coating covers an outer side of the lens body.

In summary, the method for preparing a tunable anti-reflective coating and the tunable anti-reflective coating in the present invention make a breakthrough in the design idea of a conventional anti-reflective coating. A special substrate is doped to make it possible to make adjustments corresponding to electromagnetic waves of different media separately on two sides of the substrate, and then polishing is performed to obtain an anti-reflective coating that can separately match electromagnetic waves of two different media to eliminate reflection. The tunable anti-reflective coating can overcome the problem that an anti-reflective coating in the prior art requires complex preparation, allows no coordination, and lacks universality, can adapt to anti-reflection requirements of different media, and has low preparation costs, light and thin products, and a wide application range, and therefore has great value and a development prospect in the industry.

Obviously, the foregoing embodiments are merely examples for clear description, rather than a limitation to implementations. For a person of ordinary skill in the art, other changes or variations in different forms may also be made based on the foregoing description. All implementations cannot and do not need to be exhaustively listed herein. Obvious changes or variations that are derived there from still fall within the protection scope of the invention of the present invention.

What is claimed is:

1. A method for preparing a tunable anti-reflective coating, wherein the tunable anti-reflective coating is disposed between a first medium and a second medium, and the method comprises steps of:
S1: respectively measuring electromagnetic wave impedances X₁ and X₂ of the first medium and the second medium;
S2: doping a substrate according to X₁ and X₂ to obtain a first anti-reflective coating whose internal electromagnetic wave impedance changes with a wavelength of an electromagnetic wave or a thickness;
S3: measuring an electromagnetic wave impedance X₃ on a side of the first anti-reflective coating in contact with the first medium and an electromagnetic wave impedance X₄ on a side of the first anti-reflective coating in contact with the second medium; and
S4: comparing values of X₁ and X₃, and comparing values of X₂ and X₄, and
when X₁=X₃ and X₂=X₄, obtaining a tunable anti-reflective coating that matches the first medium and the second medium respectively, or
when X₁≠X₃ and/or X₂≠X₄, adjusting the thickness of the first anti-reflective coating until X₁=X₃ and X₂=X₄, and obtaining a tunable anti-reflective coating that match the first medium and the second medium respectively.

2. The method for preparing a tunable anti-reflective coating according to claim 1, wherein the substrate is a first substrate for which wave impedance matching is performed by tuning a transverse electric wave, or a second substrate for which wave impedance matching is performed by tuning a transverse magnetic wave.

3. The method for preparing a tunable anti-reflective coating according to claim 2, wherein the first substrate is a double-zero material with both permittivity and permeability approximating to zero or a dielectric photonic crystal.

4. The method for preparing a tunable anti-reflective coating according to claim 2, wherein the second substrate is a double-zero material with both permittivity and permeability approximating to zero, or a single-zero material with a permittivity being zero and a relative permeability being 1.

5. The method for preparing a tunable anti-reflective coating according to claim 1, wherein the first medium and the second medium is independently selected from the group consisting of air, glass, silicon, silicon nitride, gallium arsenide, germanium, aluminum oxide, plastic, organic glass, iron oxide, and ferroferric oxide.

6. The method for preparing a tunable anti-reflective coating according to claim 1, wherein a doped substance in Step S2 comprises a dielectric material and a wave-absorbing material.

7. The method for preparing a tunable anti-reflective coating according to claim 6, wherein the dielectric material is selected from glass, plastic, or ceramic, and the wave-absorbing material is selected from ultrafine metal powder, silicon carbide powder, silicon carbide fiber, carbon fiber, metal fiber, or an organic polymer.

8. The method for preparing a tunable anti-reflective coating according to claim 1, wherein in Step S2, a doping ratio matches a doped substance and a type of the substrate.

9. A tunable anti-reflective coating, prepared by using the method for preparing a tunable anti-reflective coating according to claim 1.

10. A lens, comprising the tunable anti-reflective coating according to claim 9 and a lens body, wherein the tunable anti-reflective coating covers an outer side of the lens body.
